(19) United States
(12) Patent Application Publication
(10) Pub. No.: US 2013/0074511 A1
(43) Pub. Date: Mar. 28, 2013

(54) METHOD OF OPERATING A GAS TURBINE AND GAS TURBINE

(71) Applicants: Irina Tanaeva, The Hague (NL); Edwin Snoeks, The Hague (NL)

(72) Inventors: Irina Tanaeva, The Hague (NL); Edwin Snoeks, The Hague (NL)

(21) Appl. No.: 13/394,188

(22) PCT Filed: Sep. 6, 2010
(86) PCT No.: PCT/EP10/63010

§ 371 Date: Jul. 30, 2012

(30) Foreign Application Priority Data
Sep. 7, 2009 (EP) 09169606.2

(51) Int. Cl. F02C 7/143

(52) U.S. Cl. CPC F02C 7/143
USPC 60/772; 60/728

(57) ABSTRACT

A gas turbine system comprises a gas turbine having a low pressure compression stage and a high pressure compression stage, a combustion chamber, and an expansion stage connected to the combustion chamber. The low pressure compression stage and the high pressure compression stage are connected with each other via an intercooling stage, wherein the low pressure compressed air stream from the low pressure compression stage is chilled to an intercooling temperature that is lower than the ambient temperature of the air source from which the air stream was supplied to the low pressure compression stage of the gas turbine.

The present invention provides a gas turbine system, and a method of operating a gas turbine. This method may be used in a method of cooling a hydrocarbon stream. Hence, in another aspect, the invention provides a method of cooling a hydrocarbon stream, such as natural gas, to produce an at least partially, preferably fully, liquefied hydrocarbon stream.

An important example of a hydrocarbon stream to be cooled formed by natural gas. When liquefied, natural gas stream be transported and sold in the form of Liquefied Natural Gas (LNG).

Gas turbines are used in the industry for various purposes, amongst which driving generators for power generation or driving other rotating equipment such as industrial compressors.

Cooling of a hydrocarbon feed stream, or mixture of hydrocarbons, can be carried out by one or more cooling circuits comprising one of more refrigerants which are typically circulated in a refrigerant circuit. The refrigerant goes through a compression and cooling step prior to heat exchange with the hydrocarbon. The compression step utilises one or more compressors, which are often driven by a gas turbine.

The GE Energy publication GER-422A (06/04) by Michael J. Reale and titled “New High Efficiency Simple Cycle Gas Turbine—GE's LMS100™” discloses an aeroderivative gas turbine having an intercooler between low and high pressure compression stages used to compress an air stream which is passed to the combustion chamber. Ambient intercooling of the partially compressed air stream is said to provide significant benefits, reducing the work of compression for the high pressure compression stage, allowing higher pressure ratios and increasing overall efficiency. However, the efficiency is not maintained when the ambient temperature is exceptionally high.

It is an object of the invention to improve operation of the gas turbine, particularly at above average high ambient temperature conditions.

In a first aspect, the present invention provides a method of operating a gas turbine, comprising at least the steps of:

providing a gas turbine having a low pressure compression stage, a high pressure compression stage, a combustion chamber, and an expansion stage;

taking in an air inlet stream with the gas turbine from an air source which is at an ambient temperature;

compressing the air inlet stream in the low pressure compression stage to provide a low pressure compressed air stream;

passing the low pressure compressed air stream to the high pressure compression stage via an intercooling stage;
cooling the low pressure compressed air stream against ambient in an intercooling ambient cooler in the intercooling stage thereby providing an ambient-cooled compressed air stream;

chilling the ambient-cooled compressed air stream in the intercooling stage to an intercooling temperature that is lower than the ambient temperature;

compressing the chilled low pressure compressed air stream, coming from the intercooling stage, in the high pressure compression stage to provide a high pressure air stream;

passing the high pressure air stream to the combustion chamber and producing a combusted stream by allowing the high pressure air stream to oxidize a fuel stream;

expanding the combusted stream in the expansion stage;

driving the low pressure compression stage and the high pressure compression stage with mechanical power from the expansion stage.

In another aspect, the present invention provides a method of cooling a hydrocarbon feed stream to produce a liquefied hydrocarbon stream, comprising at least the steps of:

(a) circulating at least one refrigerant stream comprising a refrigerant in a refrigerant circuit, comprising compressing the refrigerant in at least a refrigerant compressor and expanding the refrigerant stream;
(b) driving the refrigerant compressor with a gas turbine;
(c) heat exchanging a hydrocarbon feed stream against at least a part of the refrigerant stream to provide an at least partially, preferably fully, liquefied hydrocarbon stream;
(d) operating the gas turbine with the method as defined above.

The liquefied hydrocarbon stream may be at least partially liquefied, and it is preferably a fully liquefied hydrocarbon stream.

In a further aspect, the present invention provides a gas turbine system comprising:

a gas turbine comprising a low pressure compressor, a high pressure compressor, a combustion chamber, and an expansion stage using an expansion turbine;

a first air inlet into the gas turbine for taking in an air inlet stream from an air source being at an ambient temperature;

a low pressure compressed air stream outlet from the gas turbine whereby the low pressure compression stage connects the first air inlet and the low pressure compressed air stream outlet;

an intercooling stage for producing an intercooled air stream from the low pressure compressed air stream, which intercooling stage is arranged to receive the low pressure compressed air stream passing through the low pressure compressed air stream outlet, the intercooling stage comprising an ambient cooler for cooling the low pressure compressed air stream against ambient thereby providing an ambient-cooled compressed air stream, followed by a heat exchanger arranged to chill the ambient-cooled compressed air stream to a temperature that is lower than the ambient temperature to produce the intercooled air stream;

a second air inlet into the gas turbine for taking in the intercooled air stream from the intercooling stage, whereby the combustion chamber is connected to the second air inlet via the high pressure compressor and to the expansion turbine;

a fuel stream inlet into the gas turbine for allowing a fuel stream into the combustion chamber;

first and second mechanical drive shafts connecting the expansion stage with the low pressure compressor and with the high pressure compressor.

The present invention will now be further illustrated by way of example, and with reference to the accompanying non-limiting drawings, in which:

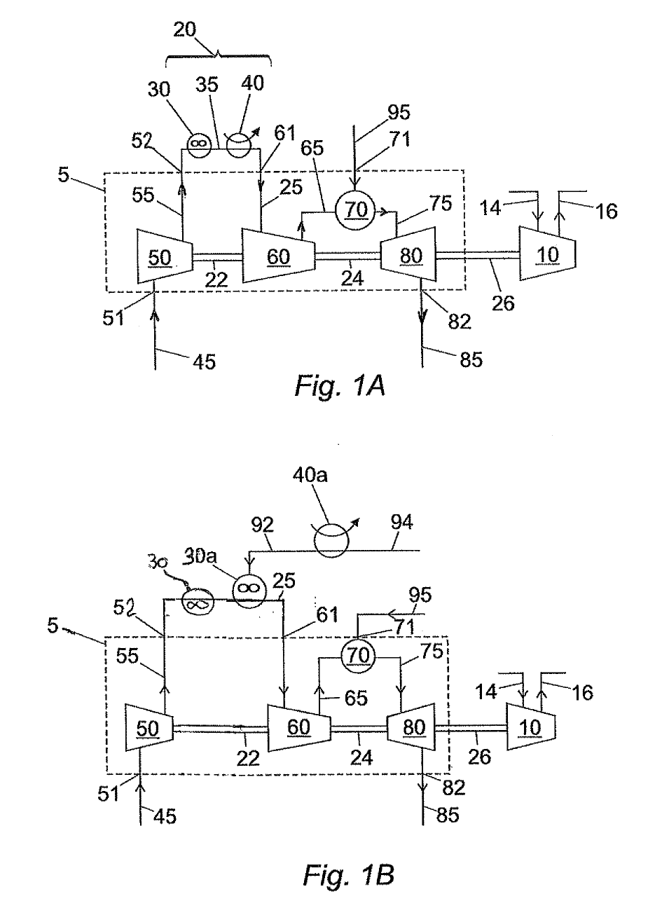

FIGS. 1A and 1B show first and second embodiments of a typical process scheme according to the method and system of the invention, in which two different intercooling line-ups are provided;

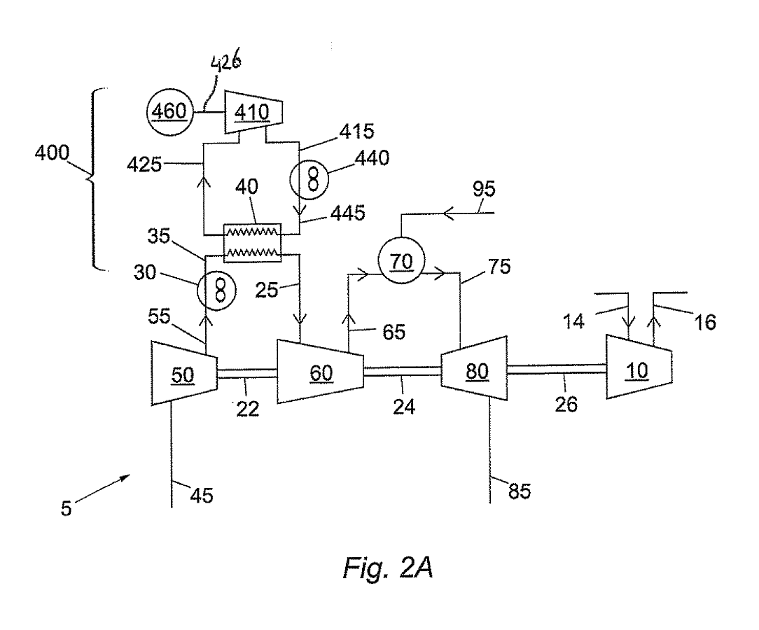

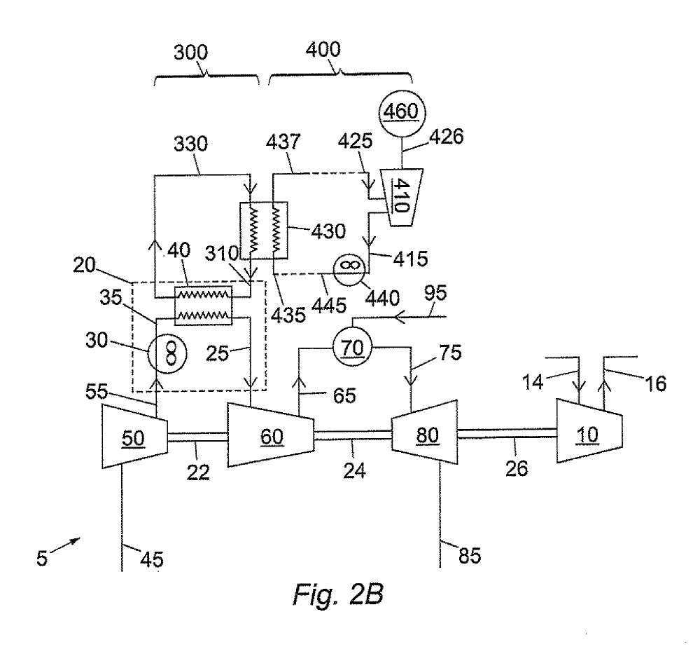

FIGS. 2A and 2B show third and fourth embodiments of a typical process scheme according to the method and system of the invention, in which simplified refrigerant circuits are provided;

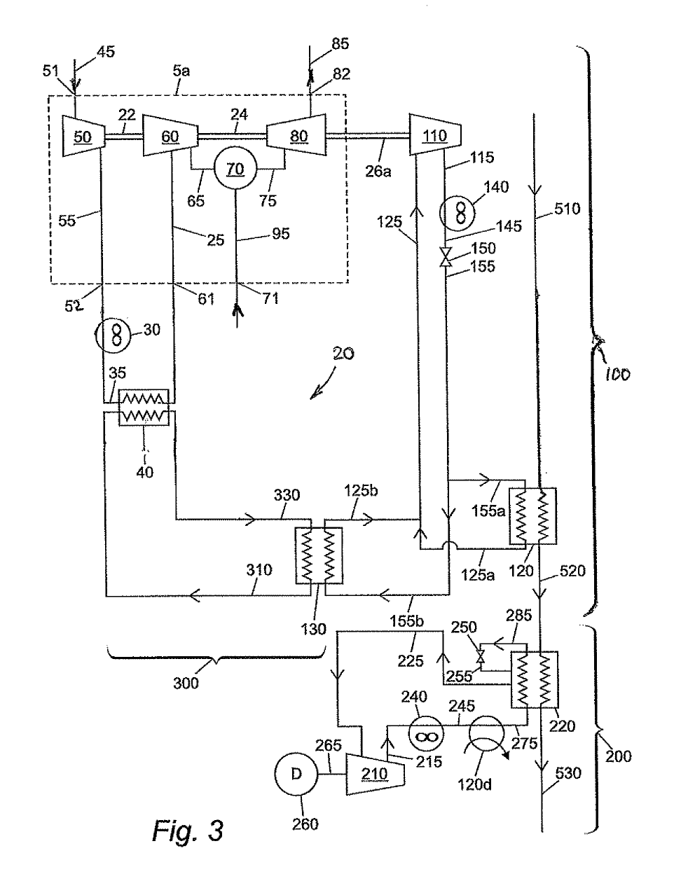

FIG. 3 shows a fifth embodiment of a typical process scheme according to the method and system of the invention, in which intercooling with cooling duty from a pre-cooling refrigerant circuit used in the cooling of a hydrocarbon feed stream is provided;

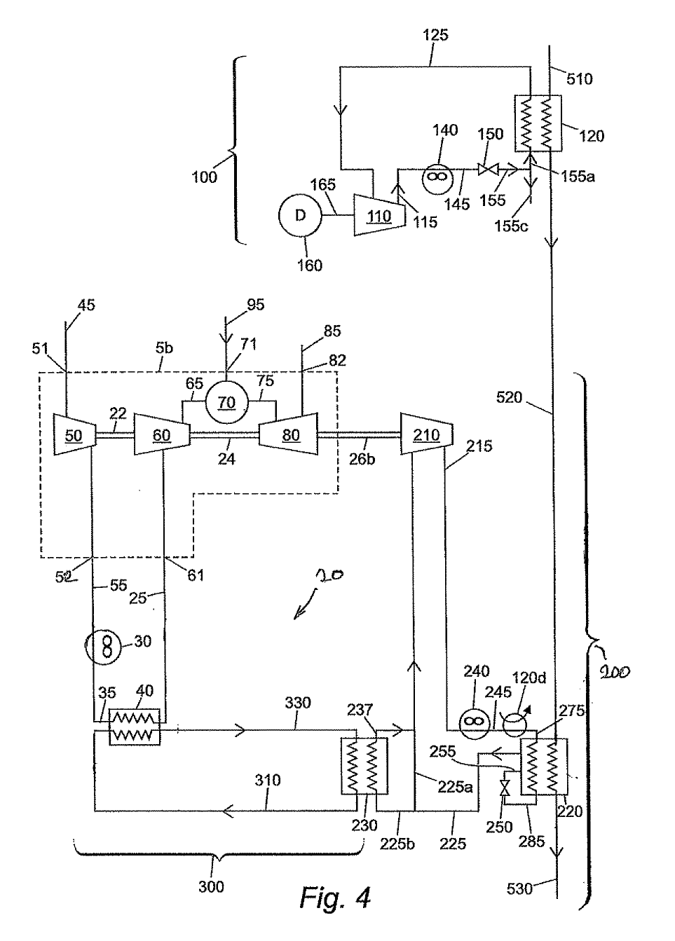

FIG. 4 shows a sixth embodiment of a typical process scheme according to the method and system of the invention, in which intercooling with cooling duty from a main refrigerant circuit used in the cooling of a hydrocarbon stream is provided;

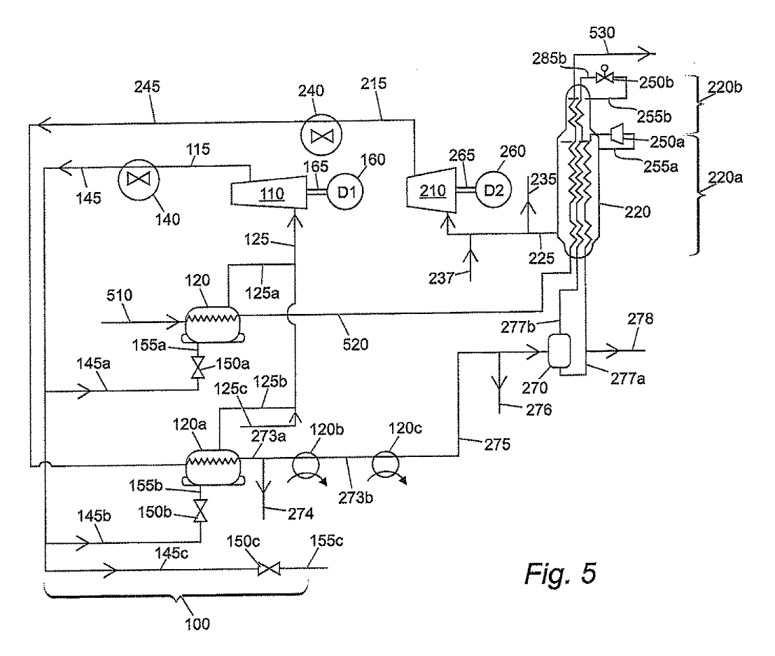

FIG. 5 shows a seventh embodiment of a typical process scheme according to the method and system of the invention, in which possible bleed points for the refrigerant used to provide cooling duty to the intercooler of the gas turbine are shown.

For the purpose of this description, a single reference number will be assigned to a line as well as a stream carried in that line. The same reference numbers refer to similar components, streams or lines.

In the method and system disclosed herein, a low pressure compressed air stream from an intercooled gas turbine is ambient-cooled against ambient and subsequently chilled in the intercooler between low and high pressure compressors (or compression stages) of the intercooled gas turbine. By chilling, the temperature of the low pressure compressed air stream between the low and high pressure compressors is reduced to below the ambient temperature, preferably below the ambient temperature by at least 5° C. This improves the operating efficiency of the gas turbine by increasing the density of the air stream more than would be the case by cooling to a temperature close to but above ambient temperature.

An advantage of ambient cooling before chilling is that the chilling duty is smaller. Moreover, the ambient cooling can be kept operative, even if the chilling is not operative for any reason, which is not possible if only chilling means is provided in the intercooling stage.

The temperature of the air source is what is considered to be “ambient temperature” in the present context. The range of temperatures that typically constitutes “ambient temperature” varies with the geographic location where the apparatus and method would be employed. However the invention is particularly beneficial if the ambient temperature is between about 5° C. and 60° C., preferably between 10° C. and 60° C., more preferably between 25° C. and 60° C.

The method and system may allow for the ability to control the low pressure compressed air stream temperature passed to the suction of the high pressure compression stage regardless of ambient temperature provides improved performance at ambient temperatures above the average operational temperature used in the plant design.

The chilling may involve using a portion of the cooling duty from a refrigerant circuit, such as a refrigerant circuit used in the cooling of a hydrocarbon stream, and/or it may involve using a portion of the cooling duty that is available in any cold process stream that is present in the plant.

Although useful in other contexts as well, the present invention is particularly advantageous when using the gas turbine system for driving one or more compressors in a liquefaction process involving methods of cooling a hydrocarbon stream to produce an at least partially liquefied hydrocarbon stream. A liquefaction unit is designed to operate at a particular ambient temperature, such as the average ambient temperature for the area where the unit is to be situated. Thus, the individual components such as the compressors are conventionally designed for average ambient conditions, with a fixed compressor head (i.e. discharge versus suction pressure ratio) versus volumetric flow curve. At higher ambient temperature conditions, the discharge pressure of the pre-cooling compressors will be higher because of the higher pre-cooling refrigerant condensing temperature in one or more ambient coolers. At a higher discharge pressure, all the pre-cooling refrigerant pressure levels will increase in pressure as well, given a relatively small pressure variation. The higher pre-cooling refrigerant pressure levels will lead to a decrease in the volumetric flow in the pre-cooling compressor, reducing the production of the liquefied hydrocarbon.

In addition, higher temperature ambient conditions will lower the power output of a gas turbine driving a refrigerant compressor such that the mass flow of refrigerant is reduced, leading to a further decrease in volumetric flow. This problem can be particularly severe in the case of aeroderivative gas turbines which are variable speed machines. In contrast to heavy duty gas turbines, aeroderivative gas turbines do not require a starter/helper motor. Starter/helper motors supplied with heavy duty gas turbines can be used to compensate for the loss of output power at higher ambient temperatures. This option would not be available in the case of aeroderivative gas turbines which are not conventionally used with a starter/helper motor.

The combination of these two effects moves the refrigerant compressor towards surge at higher ambient temperatures. The compressor may then go into recycle mode reducing the effective power input for hydrocarbon liquefaction, thus reducing liquefied hydrocarbon production. The presently proposed chilling of the low pressure compressed air stream in the intercooling stage helps mitigating these operational limits.

It is preferred that a chilled low pressure compressed air stream leaving the interstage cooling has a temperature of below 30° C., more preferably below 25° C., even more preferably below 20° C. It is also preferred that the chilled low pressure compressed air stream is not cooled below the freezing temperature of water, in order to avoid the freezing of any water vapour or liquid in the chilled low pressure compressed air stream. For example, it is preferred that the cooled low pressure compressed air stream 35 is not cooled below 5° C.

FIG. 1A shows a first embodiment of a process scheme according to the methods and systems described herein. A gas turbine 5, which may be an aeroderivative gas turbine with an intercooling stage 20, is shown driving a first compressor 10, by a first shaft 26.

The first compressor 10 is an external compressor in the sense that it is not employed for compressing an air stream being fed to the gas turbine 5 as oxydant. At least a first suction stream 14 is fed into the first compressor 10, and a first discharge stream 16 is discharged from the first compressor 10 at a higher pressure than the first suction stream 14.

In a preferred embodiment, the gas turbine 5 may be used in a method and/or plant for liquefying a hydrocarbon feed stream as a pre-cooling gas turbine. In such as case, the first compressor 10 may function as a pre-cooling compressor for compressing a pre-cooling refrigerant in a pre-cooling refrigerant circuit. A specific example of such an embodiment is further illustrated with reference to FIG. 3 below. In another embodiment, the gas turbine 5 is used in such a method and/or plant as a main cooling gas turbine and the first compressor 10 as a main cooling compressor for compressing a main cooling refrigerant in a main cooling refrigerant circuit. A specific example of such an embodiment is further illustrated with reference to FIG. 4 below. Possibilities for such embodiments are further discussed in greater detail in relation to FIG. 5 below.

The construction of the gas turbine 5 is known to the skilled person. Examples are shown in the GE Energy publication GER-422A (06/04) titled “New High Efficiency Simple Cycle Gas Turbine—GE's LMS100™”; U.S. Pat. Nos. 5,553,448, 5,724,806; US patent application publications 2002/0078689, 2004/0103637, 2005/0028529, 2006/0174627, and 2010/0058801.

The gas turbine 5 as shown in FIG. 1A comprises a first, low pressure, compression stage 50 using a first low pressure compressor 50, followed by a second, high pressure, compression stage 60 using a high pressure compressor 60, a combustion chamber 70, and an expansion stage 80 using an expansion turbine 80. The low pressure compression stage 50 and the high pressure compression stage 60 are mechanically linked by one or more first internal shafts 22. The terms low and high pressure compression stages are intended to encompass compressors housed in a single casing, or those in which multiple compressors are arranged in series on a common mechanical drive shaft or shafts, to sequentially compress the air inlet stream 45. The high pressure compression stage 60 and the expansion stage 80 are mechanically linked by one or more second internal shafts 24.

A specific example of an aeroderivative gas turbine which can be used with the present method and apparatus is the General Electric LMS100™ turbine. Details on the design, properties and operation of this turbine may be found in the GE Energy publication GER-422A (06/04) titled “New High Efficiency Simple Cycle Gas Turbine—GE's LMS100™”, which publication is incorporated herein by reference.

The LMS100™ system as described in the incorporated publication GER-422A includes a 3-spool gas turbine that uses an intercooler between the low pressure compressor (LPC) and the high pressure compressor (HPC). The LPC compressor discharges through an exit guide vane and diffuser into an aerodynamically designed scroll case. The scroll case is designed to minimize pressure losses and has been validated through ⅙ scale model testing. Air leaving the scroll case is delivered to the intercooler through stainless steel piping. Air exiting the intercooler is directed to the HPC compressor inlet scroll case. Like the LPC exit scroll case, the HPC inlet collector scroll case is aerodynamically designed for low pressure loss. This scroll case is mechanically isolated from the HPC by an expansion bellows to eliminate loading on the case from thermal growth of the core engine. The HPC discharges into the combustor. The expansion stage comprises a 2 stage high pressure turbine (HPT), a 2 stage intermediate pressure turbine (IPT) and a 5 stage power turbine (PT). The IPT drives the LPC through a mid-shaft and flexible coupling. The IPT rotor/stator assembly and mid-shaft are assembled to the core engine to create a ‘Supercore.’ The PT rotor/stator assembly is connected to the power turbine shaft assembly forming a free PT which is aerodynamically coupled to the Supercore.

An air inlet stream 45 is taken in with the gas turbine 5 from an air source via a first air inlet 51. The temperature of the air source is what is considered to be “ambient temperature” in the present context. The air inlet stream 45 is passed to the suction side of the low pressure compressor 50, where it is compressed to provide a low pressure compressed air stream 55 at the discharge. The low pressure compressed air stream 55 is then passed via a low pressure compressed air stream outlet 52 from the gas turbine 5 to an intercooling stage 20. The intercooling stage 20 discharges a discharge stream in the form of a chilled low pressure air stream 25, which is fed back into the gas turbine 5 via a second air inlet 61 provided therein. The intercooling stage 20 may comprise one or more cooling units, such as ambient coolers and other heat exchangers.

In the embodiment of FIG. 1A, the intercooling stage 20 comprises an intercooling ambient cooler 30 and an air stream heat exchanger 40. The ambient cooler 30 may be provided in the form of a conventional air-to-air or air-to-water heat exchanger which cools the low pressure compressed air stream 55 to provide an ambient-cooled compressed air stream 35. The effectiveness of the ambient cooler 30 is dependent upon the prevailing ambient conditions. As the ambient temperature increases, the temperature of the ambient-cooled compressed air stream 35 will also increase.

Therefore the intercooling stage comprises a chilling step to bring the low pressure compressed air stream 55 to an intercooling temperature that is lower than ambient temperature. This can be accomplished in various ways.

In the embodiment of FIG. 1A, the cooled compressed air stream 35 is passed to an air stream heat exchanger 40, wherein it is further cooled to provide the chilled low pressure compressed air stream 25 by consuming cooling duty from any suitable cold stream and/or a refrigerant stream that is circulated in a refrigerant circuit. By further cooling the cooled low pressure compressed air stream 35 in the air stream heat exchanger 40, the density of the stream is increased beyond that which can be achieved using ambient cooler 30 alone, such that the mass flow to the compressor blades or cylinders of high pressure compression stage 60 is increased, improving the power output of the gas turbine 5.

The chilled low pressure compressed air stream 25 is fed into the gas turbine 5 via the second air inlet 61. The pressure of the chilled low pressure air stream 25 is then increased in the high pressure compression stage 60 to provide a high pressure compressed air stream 65.

The compressed air stream 65 is passed to the combustion chamber 70, where it is mixed with a fuel stream 95 which enters into the gas turbine 5 via a fuel inlet 71, and is allowed to oxidize the fuel from the fuel stream 95 to produce a combusted stream 75 comprising combustion products. Combusted stream 75 is passed to the expansion turbine 80 of the expansion stage 80, where there may be an adiabatic expansion of the combustion products against the turbine blades, cooling the gas and extracting the thermal energy as work to turn first shaft 26. The expanded combustion products exit the expansion stage 80 and the gas turbine 5 via exhaust outlet 82 as turbine exhaust stream 85.

FIG. 1B shows an alternative configuration for the chilling of the low pressure compressed air stream 55 from the low pressure compression stage 50 of the gas turbine 5 in the intercooling stage. Those components with identical reference numerals to those of FIG. 1A have identical designations and functions. In a similar manner to the embodiment of FIG. 1A intercooling stage may be supplied with cooling duty from a refrigerant in a refrigerant circuit. However, in this embodiment the cooling duty is supplied from the refrigerant to the compressed air stream 55 via a thermal transfer fluid stream.

The refrigerant is heat exchanged in heat exchanger 40a with the thermal transfer fluid stream to provide a chilled thermal transfer fluid stream, and then the chilled thermal transfer fluid stream is heat exchanged in heat exchanger 30a with the low pressure compressed air stream 55. In the embodiment as shown, an ambient fluid stream 94, such as an air stream or a water stream, is employed as the thermal transfer fluid to produce chilled thermal transfer ambient fluid stream 92 in the form of chilled air or chilled water. The heat exchanger 30a may be a chilled air cooler or a chilled water cooler.

The cold stream, for example the refrigerant, may often comprise a flammable compound, such as a hydrocarbon component. In such a case, it is preferred that no volatile oxygen containing stream, such as the low pressure compressed air stream 55 between the low and high pressure compression stages 50, 60 of the gas turbine 5 or an ambient air stream, is heat exchanged against the cold stream/refrigerant stream in the same heat exchanger. In order to avoid the possibility of the flammable refrigerant coming into contact with volatile oxygen which may ignite it, for example due to leaks in any of the conveying pipe work, it is therefore proposed to utilise a substantially oxygen-free thermal transfer fluid to transfer the cold energy to the air stream. Alternatively, the refrigerant or cold stream itself may be substantially inflammable. For example, it may be based on CO₂.

As shown in greater detail in relation to the embodiments of FIGS. 2 to 5 below, the cooling duty required for the chilling of the low pressure compressed air stream 55 in the intercooling stage may be provided by a refrigerant stream being circulated in a refrigerant circuit. The refrigerant circuit may comprise at least a refrigerant, a refrigerant compressor driven by a refrigerant compressor driver and a refrigerant ambient cooler. In a preferred embodiment, the refrigerant circuit is a circuit in a hydrocarbon cooling, preferably liquefaction, unit, such as a LNG liquefaction unit.

The refrigerant circuit may be an independent circuit dedicated to cooling the cooled compressed air stream 35. This would require additional equipment such as a compressor, but an advantage is that no other cooling duty in the process needs to be compromised. Alternatively and or additionally, the intercooling stage 20, and particularly the air stream heat exchanger 40 component therein, may utilize cooling duty from a pre-cooling refrigerant in a pre-cooling refrigerant circuit used for the cooling of a hydrocarbon feed stream. In another further embodiment, the intercooling stage 20, and particularly the air stream heat exchanger 40 component therein, utilises cooling duty from a main refrigerant in a main refrigerant circuit used for further cooling and optionally liquefying of a pre-cooled hydrocarbon stream. The main refrigerant may itself be pre-cooled by a pre-cooling refrigerant.

FIG. 2A shows a more detailed scheme for the provision of cooling duty from a refrigerant, circulating in a refrigerant circuit 400, to the low pressure compressed air stream 55, as it may be employed in the embodiment of FIG. 1A. The refrigerant circuit 400 may be any circuit capable of providing cooling duty to the intercooling stage associated with the gas turbine 5. For instance, the refrigerant circuit 400 may be a dedicated circuit having the sole purpose of providing cooling duty to the intercooling stage, or it may provide cooling to other streams (not shown in FIG. 2A) as well.

The refrigerant circuit 400 comprises a refrigerant compressor 410 which is mechanically driven via refrigerant turbine shaft 426 by a refrigerant compressor driver 460, for example in the form of a gas turbine, an electric or other type motor, or a steam turbine. A refrigerant stream 425 is passed to the suction side of the refrigerant compressor 410. The refrigerant compressor 410 compresses the refrigerant stream 425 to provide a compressed refrigerant stream 415. The compressed refrigerant stream 415 is passed to a refrigerant ambient cooler 440, such as an air or water cooler, where it is cooled to remove a portion of the heat of compression and provide a cooled refrigerant stream 445. Cooled refrigerant stream 445 can be passed to air stream heat exchanger 40 where it cools the cooled low pressure compressed air stream 35 from the ambient air cooler 30 to provide chilled low pressure compressed air stream 25 and refrigerant stream 425, which can be returned to the suction side of the refrigerant compressor 410. A pressure reduction device, such as a Joule-Thomson valve (not shown) is typically provided to expand the cooled refrigerant stream 445 before it is used to extract heat from the air stream.

In this way, the cooling duty of the refrigerant circuit 400 can be used to further cool the cooled low pressure compressed air stream 35 to a temperature below that which can be achieved by ambient cooling alone, thereby increasing the power of the gas turbine 5.

FIG. 2B shows a more detailed scheme for the provision of cooling duty from a refrigerant in a refrigerant circuit 400 to the low pressure compressed air stream 55 via a thermal transfer fluid stream 310, as may be employed in the embodiment of FIG. 1A. This embodiment utilises a closed intermediate thermal transfer circuit 300 wherein a thermal transfer fluid is circulated.

The refrigerant circuit 400 is similar to that of the embodiment of FIG. 2A. A cooling refrigerant stream 435, derived from the cooled refrigerant stream 445, is passed to one or more intermediate heat exchangers 430, where cooling duty is removed to be passed to the low pressure compressed air stream 55 between the low and high pressure compression stages 50, 60 of the gas turbine 5. The intermediate heat exchanger 430 provides a return refrigerant stream 437 which can be passed back to the refrigerant compressor 410, for instance as refrigerant stream 425.

FIG. 2B shows dashed lines between cooled refrigerant stream 445 and cooling refrigerant stream 435, and between return refrigerant stream 437 and refrigerant stream 425. The intermediate stages between these streams are intentionally undefined in this embodiment, and do not alter the operation of the method and apparatus disclosed herein. FIGS. 3 to 5 provide specific embodiments in which the refrigerant is additionally used in the cooling of a hydrocarbon feed stream, and provide line-ups showing the specific relationships between these streams.

The thermal transfer fluid circuit 300 comprises the one or more intermediate thermal transfer heat exchangers 430 and the air stream heat exchanger 40. The thermal transfer fluid stream 330 exchanges heat in the one or more intermediate heat exchangers 430 against the cooling refrigerant stream 435, to provide the cooled thermal transfer fluid stream 310. The cooled thermal transfer fluid stream 310 is passed to the air stream heat exchanger 40, where it chills the cooled low pressure compressed air stream 35 to provide the chilled low pressure compressed air stream 25 and the thermal transfer fluid stream 330.

In case of a closed thermal transfer fluid circuit 300, the thermal transfer fluid is preferably selected from one or more of the group comprising water and a glycol, such as monoethylene glycol.

In the embodiment shown in FIG. 2B, the air stream heat exchanger 40 chills the cooled low pressure compressed air stream 35 from the ambient cooler 30. In an alternative embodiment not shown in FIG. 2B, the air stream heat exchanger 40 may cool a second thermal transfer fluid stream, such as a second air or water inlet stream, to provide a chilled second thermal transfer fluid stream that can be passed to a chilled air cooler in the intercooling stage, similar as has been discussed for the embodiment of FIG. 1B relative to streams 94 and 92 and chilled air cooler 30a.

FIGS. 3 to 5 show further embodiments of line-ups according to methods and apparatus described herein. In particular, these Figures provide schematic examples of suitable refrigeration circuits utilised in the cooling of a hydrocarbon stream.

FIG. 3 shows a method and gas turbine system described herein being applied in a method of cooling a hydrocarbon feed stream 510, for example a natural gas stream, to produce an at least partially, preferably fully, liquefied hydrocarbon stream 530, such as a Liquefied Natural Gas (LNG) stream.

The method and apparatus disclosed herein may involve at least two cooling stages, each stage having one or more steps, parts etc. For example, each cooling stage may comprise one to five heat exchangers. The or a fraction of a hydrocarbon feed stream 510 or hydrocarbon stream 520 and/or the refrigerant may not pass through all, and/or all of the same, heat exchangers of a cooling stage.

In the embodiment of FIG. 3, the hydrocarbon liquefying process comprises two cooling stages. A first cooling stage is preferably intended to reduce the temperature of a hydrocarbon feed stream 510 to below 0° C. to provide a hydrocarbon stream 520. Such a first cooling stage is termed a ‘pre-cooling’ stage, circuit or cycle 100 herein. A second or ‘main cooling’ stage 200 then further cools and at least partially, preferably fully, liquefies the hydrocarbon stream 520, preferably by cooling to a temperature below −100° C., more preferably below −150° C. to provide an at least partially liquefied hydrocarbon stream 530.

The hydrocarbon feed stream 510 may be any suitable gas stream to be cooled and optionally at least partially liquefied, but is usually a natural gas stream obtained from natural gas or petroleum reservoirs. As an alternative the hydrocarbon feed stream 510 may also be obtained from another source, also including a synthetic source such as a Fischer-Tropsch process.

When the hydrocarbon feed stream 510 is a natural gas stream, it is usually comprised substantially of methane. Preferably the hydrocarbon feed stream 510 comprises at least 50 mol % methane, more preferably at least 80 mol % methane.

Depending on the source, natural gas may contain varying amounts of hydrocarbons heavier than methane such as in particular ethane, propane and the butanes, and possibly lesser amounts of pentanes and aromatic hydrocarbons. The composition varies depending upon the type and location of the gas.

Conventionally, the hydrocarbons heavier than methane are removed to various degrees from the natural gas.

The natural gas may also contain non-hydrocarbons such as H₂O, N₂, CO₂, Hg, H₂S and other sulphur compounds, and the like, which may be removed to various degrees as well. Particularly, CO₂ and hydrocarbons heavier than butanes should be removed in order to avoid freezing out of these components during liquefaction.

Thus, if desired, the hydrocarbon feed stream 510 comprising the natural gas may be pre-treated before cooling and liquefying. This pre-treatment may comprise reduction and/or removal of undesired components such as CO₂ and H₂S or other steps such as early cooling, pre-pressurizing or the like. As these steps are well known to the person skilled in the art, their mechanisms are not further discussed here.

Thus, the term “hydrocarbon feed stream” also includes a composition prior to any treatment, such treatment including cleaning, dehydration and/or scrubbing, as well as any composition having been partly, substantially or wholly treated for the reduction and/or removal of one or more compounds or substances, including but not limited to sulphur, sulphur compounds, carbon dioxide, water, Hg, and one or more C₂₊ hydrocarbons.

To provide an at least partially, preferably fully, liquefied hydrocarbon stream 530, a hydrocarbon feed stream 510 is cooled. Initial cooling is provided by passing the hydrocarbon feed stream 510 against a pre-cooling refrigerant, which may comprise one or more C₂-C₄ hydrocarbon components, preferably propane, in a pre-cooling refrigerant circuit 100. The cooling can be carried out in one or more pre-cooling heat exchangers 120, 120d, and provides a hydrocarbon stream 520, which is cooled, optionally partially liquefied, for example at a temperature below 0° C., usually in the range −20° C. to −70° C.

The pre-cooling refrigerant circuit 100 comprises first compressors in the form of one or more pre-cooling compressors 110. The pre-cooling compressor 110 compresses a pre-cooling refrigerant stream 125 to provide a compressed pre-cooling refrigerant stream 115. These pre-cooling compressors 110 can be driven by one or more pre-cooling drivers, which are preferably pre-cooling gas turbines 5a, preferably of the type gas turbines wherein a low pressure compressed air stream between the low and high pressure compression stages 50, 60 is chilled using cooling duty from a pre-cooling refrigerant in the pre-cooling refrigerant circuit 100.

At higher ambient conditions, the discharge pressure of the pre-cooling compressor 110 will be higher because of the higher pre-cooling refrigerant condensing temperature. Conventionally a compressor is designed for operation at average ambient conditions with a fixed flow/head curve. At a higher discharge pressure, the pre-cooling refrigerant pressure levels increase in pressure.

For instance, in an embodiment in which there are multiple pre-cooling heat exchangers 120 in series, for example four pre-cooling heat exchangers at high pressure, high pressure, medium pressure and low pressure, with intermediate pressure let-down of the pre-cooling refrigerant, all the pre-cooling refrigerant pressure levels will increase even if there is only a relatively small head variation. Higher pre-cooling refrigerant pressure levels will lead to a corresponding reduction in the volumetric flow in the pre-cooling compressor.

Similarly, in an alternative embodiment (not shown), there may be multiple pre-cooling heat exchangers in parallel. Again, higher pre-cooling refrigerant pressure levels will lead to a corresponding reduction in the volumetric flow of the pre-cooling compressor.

In order to handle this, the power output of the pre-cooling compressor driver is increased by chilling a low pressure compressed air stream in the intercooling stage 20. In the embodiment of FIG. 3, the cooling duty is derived from the pre-cooling refrigerant circuit using an air stream heat exchanger 40. The pre-cooling gas turbine 5a comprises identical components to the gas turbine 5 discussed in relation to FIG. 1A, which have been given the same reference numerals.

Returning to the pre-cooling refrigerant circuit 100, the compressed pre-cooling refrigerant stream 115 from the discharge of the pre-cooling compressor 110 is passed to one or more pre-cooling ambient coolers 140, such as air or water coolers. The pre-cooling ambient coolers 140 cool the compressed pre-cooling refrigerant stream 115 to remove heat of compression and heat that has been absorbed in the course of cooling streams 510 and 330, and thereby to provide a cooled pre-cooling refrigerant stream 145.

The cooled pre-cooling refrigerant stream 145, or at least a part thereof, is then passed through one or more pre-cooling expansion devices 150, such as a Joule-Thomson valve or a turboexpander, to provide one or more expanded cooled pre-cooling refrigerant streams 155. At least a first part 155a of the expanded cooled pre-cooling refrigerant stream 155 is passed to the pre-cooling heat exchanger 120, where it cools the hydrocarbon feed stream 510 to provide hydrocarbon stream 520 and a first part 125a of the pre-cooling refrigerant stream 125.

A second part 155b of the expanded cooled pre-cooling refrigerant stream 155 can be passed to one or more intermediate heat exchangers 130, where at least a portion of the cooling duty of the pre-cooling refrigerant circuit 100 can be removed to chill the low pressure compressed air stream 55 between the low and high pressure compression stages 50, 60 of the pre-cooling gas turbine 5a, as discussed for FIG. 2B. Optionally, the second part 155b of the expanded pre-cooling refrigerant stream 155 may be passed through an expansion device (not shown), prior to passing it to one or more intermediate heat exchangers 130.

Having passed through the one or more intermediate heat exchangers 130, the second part 125b of the pre-cooling refrigerant stream 125 can then be combined with the first part 125a to provide the pre-cooling refrigerant stream 125, which is then passed to the suction of pre-cooling compressor 110.

The cooled thermal transfer fluid stream 310 provided by heat exchange from the second part 155b of the expanded cooled pre-cooling refrigerant stream 155 can then be passed to one or more air stream heat exchangers 40. The air steam heat exchanger 40 chills the cooled low pressure compressed air stream 35 to provide chilled low pressure compressed air stream 25 which is fed to high pressure compression stage 60 of the pre-cooling gas turbine 5a. At the same time, the thermal transfer fluid stream 330 is regenerated, to be returned to the intermediate heat exchanger 130.

The pre-cooled hydrocarbon stream 520 is then passed to one or more main heat exchangers 220 where it is further cooled and at least partially, preferably fully, liquefied against a main refrigerant in a main refrigerant circuit 200 to provide the at least partially liquefied hydrocarbon stream 530.

The main refrigerant circuit 200 is preferably separate from the pre-cooling refrigerant circuit 100, but need not be. Semi-open and fully open refrigerant circuits are also envisaged, such as an embodiment in which the pre-cooling and main cooling refrigerants are different compositions of a mixed refrigerant in linked circuits.

The main cooling circuit 200 is preferably intended to reduce the temperature of the hydrocarbon stream 520, usually at least a fraction of a hydrocarbon stream cooled by the pre-cooling cooling stage, to below −100° C., more preferably below −120° C., even more preferably below −150° C. The main refrigerant circuit 200 can comprise one or more main heat exchangers 220, which can be separate from the pre-cooling heat exchangers 120.

Heat exchangers for use as the one or more pre-cooling heat exchangers 120 or the one or more main heat exchangers 220 are well known in the art. At least one of the main heat exchangers 220 is preferably a spool-wound cryogenic heat exchanger known in the art. Optionally, a heat exchanger could comprise one or more cooling sections within its shell, and each cooling section could be considered as a cooling stage or as a separate ‘heat exchanger’ to the other cooling locations.

The main refrigerant in the main refrigerant circuit 200 is preferably a mixed refrigerant. A mixed refrigerant or a mixed refrigerant stream as referred to herein comprises at least 5 mol % of two different components. A common composition for a mixed refrigerant is:

| | |
|---|---|
| Nitrogen | 0-10 mol % |
| Methane (C1) | 30-70 mol % |
| Ethane (C2) | 30-70 mol % |
| Propane (C3) | 0-30 mol % |
| Butanes (C4) | 0-15 mol % |

but other compositions may be employed if desired.

The total composition comprises 100 mol %. The mixed refrigerant of the main refrigerant circuit 200 may be formed from a mixture of two or more components selected from the group comprising: nitrogen, methane, ethane, ethylene, propane, propylene, butanes, etc. The method and apparatus disclosed herein may further involve the use of one or more other refrigerants, in separate or overlapping refrigerant circuits or other cooling circuits.

The main refrigerant circuit 200 comprises a main refrigerant stream 225, which is passed to the one or more main refrigerant compressors 210. The main refrigerant compressor 210 is mechanically driven by a main compressor driver 260, via main compressor shaft 265. The main compressor driver 260 can be any conventional driver, such as an electric driver or a gas turbine.

The main refrigerant compressor 210 compresses the main refrigerant stream 225 to provide a compressed main refrigerant stream 215. The compressed main refrigerant stream 215 is then cooled in one or more main refrigerant ambient coolers 240, such as air or water coolers, to provide a cooled main refrigerant stream 245.

In yet another embodiment disclosed herein, the main refrigerant can be passed through one or more heat exchangers, preferably two or more of the pre-cooling 120 and main 220 heat exchangers described hereinabove, to provide one or more cooled main refrigerant streams.

In a preferred embodiment shown in FIG. 3, the cooled main refrigerant stream 245 is further cooled in one or more of the pre-cooling heat exchangers 120d in the pre-cooling refrigerant circuit 100, against a part of the expanded cooled pre-cooling refrigerant stream 155, to provide a pre-cooled main refrigerant stream 275. The pre-cooled main refrigerant stream 275 may be an at least partly and preferably a fully liquefied stream.

In a preferred embodiment, at least a part of the expanded cooled pre-cooling refrigerant stream cools the cooled main refrigerant stream 245 to a specific temperature, the crossover or cut-off temperature, such that the pre-cooled main refrigerant stream 275 is provided at a specific temperature.

In a further embodiment, the pre-cooling heat exchanger 120 can cool both the cooled main refrigerant stream 245 and the hydrocarbon feed stream 510 against at least a part of the expanded cooled pre-cooling refrigerant stream 155, such that the pre-cooling heat exchanger 120 shown in the pre-cooling refrigerant circuit 100 is the same heat exchanger as the pre-cooling heat exchanger 120d in the main refrigerant circuit 200. An example of a different line-up where different pre-cooling heat exchangers are used to cool the hydrocarbon feed stream and the cooled main refrigerant stream is provided in FIG. 5 discussed below.

The pre-cooled main refrigerant stream 275 is then passed to the main heat exchanger 220 where it can be cooled against itself. For example, when the main heat exchanger 220 is a shell and tube heat exchanger the pre-cooled main refrigerant stream 275 can be passed along one or more tubes and cooled against main refrigerant on the shell side to provide a further cooled main refrigerant stream 285. The further cooled main refrigerant stream 285 can then be expanded in a main expansion device 250, such as a Joule-Thomson valve or turboexpander, to provide an expanded cooled main refrigerant stream 255 which can then be passed to the main heat exchanger 220 to cool the pre-cooled main refrigerant stream 275 and at least partially liquefy the hydrocarbon stream 520. In a preferred embodiment, the expanded cooled main refrigerant stream 255 can be passed to the shell side of the main heat exchanger 220.

In cooling the pre-cooled main refrigerant stream 275 and at least partially liquefying the hydrocarbon stream 520, the expanded cooled main refrigerant stream 255 is warmed and may be at least partially evaporated. The warmed main refrigerant leaves the main heat exchanger as main refrigerant stream 225 and can be passed back to the main compressor 210.

Thus, embodiments as illustrated in FIG. 3, a portion of the cooling duty from the pre-cooling refrigerant circuit 100 can be passed to the intercooler 20 of the pre-cooling gas turbine 5a to increase the cooling of the low pressure compressed air stream 55 beyond that available from the ambient cooler 30. It is therefore possible to mitigate the reduction in power level resulting from increased ambient temperatures, where a gas turbine having only an ambient cooler as intercooler would begin to experience a reduction in power output.

It is also envisaged that a portion of the cooling duty from the pre-cooling refrigerant circuit 100 could be passed to an intercooling stage of the main gas turbine 260 driving the main refrigerant compressor 210, to provide additional cooling of a low pressure compressed air stream between the low and high pressure compression stages of the gas turbine. This could be done in combination with the cooling of the intercooler of the pre-cooling gas turbine 5a using cooling duty from the pre-cooling refrigerant circuit 100, or provided as an alternative to the cooling of the intercooling stage of the pre-cooling gas turbine 5a.

An advantage of employing duty from the pre-cooling refrigerant circuit 100 for the chilling of the low compressed air stream in the intercooling stage of the gas turbine system, is that the pre-cooling refrigerant is usually well optimized for extracting heat from other streams at the desired temperature level which is not a very low temperature level. Thus, the thermal efficiency of said chilling is high.

FIG. 4 shows a further embodiment of a method and apparatus described herein applied to the production of an at least partially, preferably fully, liquefied hydrocarbon stream 530, such as a Liquefied Natural Gas (LNG) stream, from a hydrocarbon feed stream 510, such as a natural gas stream. In a similar manner to FIG. 3, a two-stage cooling system is provided which comprises pre-cooling 100 and main cooling 200 refrigerant circuits.

In this embodiment, the gas turbine is a main gas turbine 5b which drives the first compressor in the form of a main refrigerant compressor 210 via main shaft 26b. The main gas turbine 5b is provided with an intercooling stage 20 comprising an ambient cooler 30 and an air stream heat exchanger 40. Cooling duty from the main refrigerant in the main refrigerant circuit 200 is provided to the low pressure compressed air stream 55, specifically via the air stream heat exchanger 40.

The pre-cooling refrigerant circuit 100 is similar in configuration to that of the embodiment of FIG. 3, with the exception that a third part 155c of the expanded cooled pre-cooling refrigerant stream 155 is also withdrawn from the stream. A first part 155a of the expanded pre-cooling refrigerant stream 155 can be passed to the pre-cooling heat exchanger 120 to cool the hydrocarbon feed stream 510, while an optional third part 155c can be passed to a pre-cooling heat exchanger 120d in the main refrigerant circuit 200 to further cool the cooled main refrigerant stream 245 to provide a pre-cooled main refrigerant stream 275 to the main heat exchanger 220. The pre-cooling refrigerant can then be returned to pre-cooling refrigerant stream 125 exiting the pre-cooling heat exchanger 120 to be passed to the pre-cooling compressor 110, which is mechanically driven by pre-cooling driver 160 pre-cooling shaft 165.

With regard to the main refrigerant circuit 200, a second part 225b of the main refrigerant stream 225 exiting the main heat exchanger 220 can be passed to intermediate heat exchanger 230, as a cooling main refrigerant stream. The second part 225b of the main refrigerant stream 225 can be heat exchanged against a thermal transfer fluid stream 330, such as water or a glycol, to provide a cooled thermal transfer fluid stream 310, and a main refrigerant return stream 237. The main refrigerant return stream 237 can be combined with the first part 225a of the main refrigerant stream 225 from the main heat exchanger 220 and passed to the suction of main compressor 210 as the main refrigerant stream 225.

The cold energy from the main refrigerant can then be passed to the air inlet heat exchanger 40 by the cool thermal transfer fluid stream 310, where it is used to chill the cooled low pressure compressed air stream 35 from the ambient cooler 30 to provide a chilled low pressure compressed air stream 25 to the suction side of the high pressure compression stage 60 of the main gas turbine 5b.

In this way, a portion of the cooling duty from the main refrigerant circuit 200 can be passed to the intercooling stage 20 of the main gas turbine 5b to increase the cooling of the low pressure compressed air stream 55 beyond that available from the ambient cooler 30. It is therefore possible to mitigate the reduction in power level resulting from increased ambient temperatures where a gas turbine having only an ambient cooler as the intercooling stage would begin to experience a reduction in power output.

It is also envisaged that a part of the cooling duty from the main refrigerant circuit 200 could be passed to an intercooling stage of the pre-cooling gas turbine 160, to provide additional cooling of a low pressure compressed air stream between low and high pressure compression stages of the pre-cooling gas turbine. This could be done in combination with the cooling of the intercooling stage 20 of the main gas turbine 5b using cooling duty from the main refrigerant circuit 200, or provided as an alternative to the cooling of the intercooler of the main gas turbine 5b.

An advantage of employing duty from the main refrigerant circuit 200 over the pre-cooling refrigerant circuit 100, for the chilling of the low compressed air stream in the intercooling stage of the gas turbine system, is that the main refrigerant circuit is less stressed under high ambient temperature than the pre-cooling refrigerant circuit. Therefore, there may be excess refrigeration duty at high ambient temperutre available in the main refrigerant circuit 200 when compared to the pre-cooling refrigerant circuit 100. Without intending to be limited to this theory, applicants believe that this is due to the fact that the main refrigerant is not or to a lesser extent condensed against the ambient. However, the efficiency is not so high, since the main refrigerant is not optimized for extracting heat at the intercooling chilling temperature level.

FIG. 5 provides a more detailed scheme of a hydrocarbon cooling and at least partly liquefying process such as the general scheme shown in FIGS. 3 and 4. A hydrocarbon feed stream 510, which may have been pre-treated to reduce and/or remove at least some of the non-hydrocarbons, and optionally some of the hydrocarbons heavier than methane as discussed hereinabove, is passed to pre-cooling heat exchanger 120.

The hydrocarbon feed stream 510 passes through the pre-cooling heat exchanger 120, which may comprise one or more heat exchangers in series, parallel, or both, in a manner known in the art to provide hydrocarbon stream 520 and is cooled and preferably partially liquefied.

The cooling in the pre-cooling exchanger 120 is provided by a pre-cooling refrigerant, such as propane, in an expanded cooled pre-cooling refrigerant stream 155a.

The pre-cooling compressor 110 provides a compressed pre-cooling refrigerant stream 115, which is cooled in pre-cooling cooler 140 to provide a cooled pre-cooling refrigerant stream 145. The cooled pre-cooling refrigerant stream 145 is split into first, second and third part pre-cooling refrigerant streams 145a, 145b, 145c and passed to first, second and third pre-cooling expansion devices 150a, 150b, 150c, in which the respective streams are expanded to provide first, second and third expanded cooled pre-cooling refrigerant streams 155a, 155b, 155c.

The expanded cooled pre-cooling refrigerant stream 155a is passed to the pre-cooling heat exchanger 120 to cool the hydrocarbon feed stream 510 to provide hydrocarbon stream 520. The second expanded cooled pre-cooling refrigerant stream 155b is discussed below in relation to the main cooling circuit.

At least a third expanded pre-cooling refrigerant stream 155c can be passed to a heat exchanger to provide cooling duty to the intercooler of a selected gas turbine in accordance with the method disclosed herein. The construction of the intercooled gas turbine systems are not shown in FIG. 5 for simplicity. After having extracted heat from the gas turbine intercooler, the pre-cooling refrigerant is passed to the pre-cooling refrigerant stream 125 as third part pre-cooling refrigerant stream 125c.

In the scheme shown in FIG. 5, the expanded cooled pre-cooling refrigerant stream 155a is shown passing into the bottom or lower part of the pre-cooling heat exchanger 120, which can be a shell and tube heat exchanger. After providing cooling in the pre-cooling heat exchanger 120, the pre-cooling refrigerant can be least partly evaporated, usually fully evaporated, and exits the pre-cooling heat exchanger at or near the top as the first part 125a of pre-cooling refrigerant stream 125.

First part 125a of pre-cooling refrigerant stream 125 is combined with the second and third parts 125b, 125c of the pre-cooling refrigerant stream 125 to provide pre-cooling refrigerant stream 125 and passed to the suction side of pre-cooling compressor 110, which is mechanically driven by pre-cooling driver 160 via pre-cooling shaft 165. Pre-cooling driver 160 is preferably a pre-cooling gas turbine. The pre-cooling gas turbine can have an intercooling stage where a low pressure compressed air stream between the low and high pressure compression stages is chilled by the method and gas turbine systems disclosed herein.

The hydrocarbon stream 520 is cooled and at least partially, preferably fully, liquefied in main heat exchanger 220. Main heat exchanger 220 has two sections, a lower section 220a, and an upper section 220b. These are shown in FIG. 5 as a lower main heat exchanger 220a and an upper main heat exchanger 220b. The arrangement of two or more heat exchangers as sections in a, for example cryogenic, heat exchanger are known in the art, and are not further discussed herein.

After the hydrocarbon stream 520, which is cooled and preferably partially liquefied, is passed through the main heat exchangers 220a, 220b, there is provided an at least partially, preferably fully, liquefied hydrocarbon stream 530. Cooling of the hydrocarbon stream 520 in the main upper and lower heat exchangers 220a, 220b is provided by two fractions of the main refrigerant, which is a mixed refrigerant, which fractions enter the main heat exchanger 220 at different locations, so as to provide the different heat-exchanging sections within the main heat exchanger 220 in a manner known in the art. At or near the base of the lower main heat exchanger 220a, the mixed refrigerant after its use can be collected as main refrigerant stream 225, which can be an at least partly evaporated mixed refrigerant stream, which can pass through a refrigerant gas/liquid separator, such as a knock-out drum (not shown) and on to main compressor 210.

Main compressor 210 is mechanically driven by main driver 260 via main shaft 265. Main driver 260 can be a main gas turbine. The main gas turbine may be connected to an intercooling stage where a low pressure compressed air stream between the low and high pressure compression stages is chilled by the method and gas turbine system disclosed herein.

One or both of the pre-cooling driver 160 and main cooling driver 260 must involve a gas turbine system with an intercooling stage chilled by the method disclosed herein.

The main refrigerant stream 225 is compressed by main compressor 210 to provide compressed main refrigerant stream 215 and cooled by one or more main ambient coolers 240 to provide cooled main refrigerant stream 245. The cooled main refrigerant stream 245 can be passed through one or more pre-cooling heat exchangers 120a, b, c. Where there are more than two pre-cooling heat exchangers 120, such as 3, 4 or 5 of such heat exchangers, one or both of the hydrocarbon feed stream 510, and the cooled main refrigerant stream 245, may not pass through all of these pre-cooling heat exchangers 120, but may be selected to pass through certain of the pre-cooling heat exchangers 120 to provide a particular arrangement of cooling to the two streams in a manner known in the art. FIG. 5 shows the hydrocarbon feed stream 510 passing through a pre-cooling heat exchanger 120, while the cooled main refrigerant stream 245 is passed through three pre-cooling heat exchangers, namely second, third and fourth pre-cooling heat exchangers 120a, 120b, 120c, which are different heat exchangers from the pre-cooling heat exchanger 120.

The hydrocarbon feed stream 510 and cooled main refrigerant stream 245 are cooled against first and second parts 145a, 145b of the cooled pre-cooling refrigerant stream 145 after expansion in first and second pre-cooling expansion devices 150a, b respectively. First and second pre-cooling expansion devices 150a, b provide first and second expanded cooled pre-cooling refrigerant streams 155a, 155b, which can be heat exchanged in the pre-cooling heat exchanger 120 and second pre-cooling heat exchanger 120a respectively. In doing so, the pre-cooling refrigerant is warmed in the pre-cooling heat exchangers 120, 120a to provide first and second parts 125a, 125b of a pre-cooling refrigerant stream respectively, which can then be combined to provide pre-cooling refrigerant stream 125 and passed to the suction side of pre-cooling compressor 110.

For simplicity, the provision of the pre-cooling refrigerant, for instance after appropriate pressure reduction, to the third and fourth pre-cooling heat exchangers 120b, 120c is not shown in FIG. 5. Such a line-up is known in the art.

Thus, the cooled main refrigerant stream 245 is further cooled by its sequential passage through the three pre-cooling heat exchangers 120a, b, c to provide, in order, a first and a second intermediate pre-cooled main refrigerant stream 273a and 273b prior to the provision of the pre-cooled main refrigerant stream 275 after the fourth pre-cooling heat exchanger 120c. Pre-cooled main refrigerant stream 275 is preferably provided at a predetermined cross over or cut-off temperature, which can be passed to a main gas/liquid separator 270 to provide an overhead gaseous stream 277b and a liquid bottom stream 277a.

The overhead gaseous stream 277b from the main gas/liquid separator 270, commonly also termed a light mixed refrigerant stream (LMR), passes through the main heat exchanger 220 to provide an upper further cooled main refrigerant stream 285b, which passes through an expansion device, such as upper valve 250b to provide an upper expanded cooled main refrigerant stream 255b for cooling in the upper main heat exchanger 220b in a manner known in the art.

The liquid bottom stream 277a from the main gas/liquid separator 270, commonly also termed a heavy mixed refrigerant stream (HMR), passes through the lower main heat exchanger 220a to provide a lower further cooled main refrigerant stream 285a, which passes through an expansion device, such as lower valve 250a to provide a lower expanded cooled main refrigerant stream 255a for cooling in the lower main heat exchanger 220a in a manner known in the art.

The scheme of FIG. 5 illustrates a number of positions where the main refrigerant can be drawn from the main refrigerant circuit 200 to provide cooling duty to the intercooler of at least one of the gas turbine systems.

As discussed for FIG. 4, a part (cooling main refrigerant stream) 235 of main refrigerant stream 225, which can be at a temperature of approximately −30° C. and a pressure in the range of 3.0 to 4.5 bar, can be withdrawn and passed to the intercooling stage to provide cooling duty to the intercooler of one or both of the pre-cooling compressor gas turbine 160 and the main compressor gas turbine 260 if one or both of these are gas turbines with intercooling stages. After extraction of the cold energy from the cooling main refrigerant stream 235, the main refrigerant can be passed back as return main refrigerant stream 237, where it is returned to the main refrigerant stream 225 which is passed to the main compressor 210.

Alternatively, a part of the intermediate pre-cooled main refrigerant stream 273 can be withdrawn from between two of the pre-cooling heat exchangers 120a, b, c and passed to the intermediate heat exchanger in order to provide cooling duty to one or both of any intercooling stages of the gas turbines 160, 260. FIG. 5 shows a part 274 of first intermediate pre-cooled main refrigerant stream 273a being withdrawn from between the second and third pre-cooling heat exchangers 120a, 120b. After providing cooling duty to the selected intercooling stage, the main refrigerant can be passed back to the main refrigerant stream 225 as return main refrigerant stream 237 after appropriate pressure reduction.

In a further alternative, a part 276 of the pre-cooled main refrigerant stream 275 can be withdrawn prior to separation in the main gas/liquid separator 270, expanded and used to provide cooling duty to the selected intercooling stage. For instance, part stream 276 can be expanded to a pressure of approximately 3-4.5 bar providing a temperature of approximately −75 to −80° C. and used to cool the thermal transfer fluid. After providing the desired cooling duty, the refrigerant can be passed back as return main refrigerant stream 237, after suitable pressure reduction and provided to the main refrigerant compressor 210.

In a yet further alternative, a part 278 of the bottoms liquid (heavy mixed refrigerant) stream 277a can be withdrawn after separation in the main gas/liquid separator 270, and used to provide cooling duty to the selected intercooling stage. After having provided cooling duty, the refrigerant could be returned to the bottoms liquid stream 277a or passed back as return main refrigerant stream 237 after appropriate pressure reduction.

In an alternative embodiment, not shown in any figure, the one or more pre-cooling compressors 110 and the one or more main refrigerant compressors 210 may be driven on a single by a single gas turbine operated in accordance with the invention.

In a further embodiment not shown in the Figures, cooling duty from the refrigerant circuit, such as a pre-cooling or main cooling refrigerant circuit, can also be used to chill the air inlet stream 45 to the gas turbine 5 to achieve a chilled air inlet stream that has an inlet temperature that is below the ambient temperature. Chilling the air inlet stream to the low pressure compression stage of the gas turbine increases the density of the air stream and can improve the efficiency of the gas turbine in a similar manner to the cooling of a low pressure compressed stream between the low and high pressure compression stages of the gas turbine.

The person skilled in the art will understand that the present invention can be carried out in many various ways without departing from the scope of the appended claims.

1. A method of operating a gas turbine, comprising at least the steps of:
providing a gas turbine having a low pressure compression stage, a high pressure compression stage, a combustion chamber, and an expansion stage;
taking in an air inlet stream with the gas turbine from an air source which is at an ambient temperature;
compressing the air inlet stream in the low pressure compression stage to provide a low pressure compressed air stream;
passing the low pressure compressed air stream to the high pressure compression stage via an intercooling stage;
cooling the low pressure compressed air stream against ambient in an intercooling ambient cooler in the intercooling stage thereby providing an ambient-cooled compressed air stream;
chilling the ambient-cooled compressed air stream in the intercooling stage to an intercooling temperature that is lower than the ambient temperature;
compressing the chilled low pressure compressed air stream coming from the intercooling stage in the high pressure compression stage to provide a high pressure air stream;
passing the high pressure air stream to the combustion chamber and producing a combusted stream by allowing the high pressure air stream to oxidize a fuel stream;
expanding the combusted stream in the expansion stage; and
driving the low pressure compression stage and the high pressure compression stage with mechanical power from the expansion stage.

2. The method according to claim 1, further comprising chilling the air inlet stream to an inlet temperature that is below the ambient temperature.

3. The method according to claim 1, wherein said chilling of the low pressure compressed air stream in the intercooling stage consumes cooling duty from a refrigerant being circulated in a refrigerant circuit.

4. The method according to claim 3, wherein said consuming of cooling duty from the refrigerant being circulated in the refrigerant circuit by the chilling of the low pressure compressed air stream comprises heat exchanging the refrigerant being circulated in the refrigerant circuit with a thermal transfer fluid stream to provide a chilled thermal transfer fluid stream, and heat exchanging the chilled thermal transfer fluid stream with the low pressure compressed air stream.

5. The method according to claim 4, wherein the thermal transfer fluid is circulated in a closed thermal transfer fluid circuit, and selected from the group consisting of: water and a glycol.

6. The method according to claim 4, wherein the thermal transfer fluid is provided in the form of an ambient fluid stream.

7. The method according to claim 1, wherein the gas turbine drives a first compressor, which is an external compressor, and wherein the first compressor compresses a first suction stream to produce a first discharge stream.

8. The method according to claim 7, wherein the first suction stream is a refrigerant stream.

9. The method according to claim 1, wherein the gas turbine drives a first compressor, which is an external compressor, and wherein the first compressor compresses a first suction stream to produce a first discharge stream, wherein the first suction stream is comprises refrigerant from the refrigerant circuit.

10. A method of cooling a hydrocarbon feed stream to produce an at least partially liquefied hydrocarbon stream, comprising at least the steps of:
(a) circulating at least one refrigerant stream comprising a refrigerant in a refrigerant circuit, said circulating comprising compressing the refrigerant in at least a first compressor and expanding the refrigerant stream;
(b) driving the first compressor with a gas turbine;
(c) heat exchanging a hydrocarbon feed stream against at least a part of the refrigerant stream to provide an at least partially liquefied hydrocarbon stream; and
(d) operating the gas turbine with the method according to any one of the preceding claims.

11. The method according to claim 10, wherein said at least partially liquefied hydrocarbon stream is a fully liquefied hydrocarbon stream.

12. A gas turbine system comprising:
a as turbine comprising a low pressure compressor, a high pressure compressor, a combustion chamber, and an expansion stage using an expansion turbine;
a first air inlet into the gas turbine for taking in an air inlet stream from an air source at an ambient temperature;
a low pressure compressed air stream outlet from the gas turbine whereby the low pressure compression stage connects the first air inlet and the low pressure compressed air stream outlet;
an intercooling stage for producing an intercooled air stream from the low pressure compressed air stream, which intercooling stage is arranged to receive the low pressure compressed air stream passing through the low pressure compressed air stream outlet, the intercooling stage comprising an ambient cooler for cooling the low pressure compressed air stream against ambient thereby providing an ambient-cooled compressed air stream, followed by a heat exchanger arranged to chill the ambient-cooled compressed air stream to a temperature that is lower than the ambient temperature to produce the intercooled air stream;
a second air inlet into the gas turbine for taking in the intercooled air stream from the intercooling stage, whereby the combustion chamber is connected to the second air inlet via the high pressure compressor and to the expansion turbine;
a fuel stream inlet into the as turbine for allowing a fuel stream into the combustion chamber; and
first and second mechanical drive shafts connecting the expansion stage with the low pressure compressor and with the high pressure compressor.

13. The apparatus according to claim 12, wherein the first and second mechanical drive shafts connect the expansion turbine in the expansion stage with the low pressure compressor and with the high pressure compressor.
